(19) United States
(12) Patent Application Publication
(10) Pub. No.: US 2012/0019512 A1
(43) Pub. Date: Jan. 26, 2012

(54) NOISE SUPPRESSION FOR CONE-BEAM IMAGE RECONSTRUCTION

(76) Inventors: Dong Yang, Rochester, NY (US); Nathan J. Packard, Rochester, NY (US); Robert A. Senn, Pittsford, NY (US); John Yorkston, Penfield, NY (US); David H. Foos, Rochester, NY (US)

(21) Appl. No.: 12/841,363

(22) Filed: Jul. 22, 2010

(51) Int. Cl. G06T 15/00; G06K 9/00

(52) U.S. Cl. 345/419; 382/154; 382/131

(57) ABSTRACT

A method for 3-D volume image reconstruction of a subject, executed at least in part on a computer, obtains image data for 2-D projection images over a range of scan angles. For each of the plurality of projection images, a noise-corrected projection image is generated by steps of transforming the image data according to a variance-stabilizing transform to provide transformed image data, applying Gaussian based noise suppression to the transformed image data, and inverting the transformation of the noise-suppressed transformed image data to generate the noise-corrected projection image. The noise-corrected projection image is stored in a computer-accessible memory.

### FIELD OF THE INVENTION

The invention relates generally to the field of diagnostic imaging and in particular to Cone-Beam Computed Tomography (CBCT) imaging. More specifically, the invention relates to a method for improved noise compensation in reconstruction of CBCT image content.

### BACKGROUND OF THE INVENTION

Three-dimensional (3-D) volume imaging has proved to be a valuable diagnostic tool that offers significant advantages over earlier two-dimensional (2-D) radiographic imaging techniques for evaluating the condition of internal structures and organs. 3-D imaging of a patient or other subject has been made possible by a number of advancements, including the development of high-speed imaging detectors, such as digital radiography (DR) detectors that enable multiple images to be taken in rapid succession.

Conventional computed tomography CT scanners direct a fan-shaped X-ray beam through the patient or other subject and toward a one-dimensional detector, reconstructing a succession of single slices to obtain a volume or 3-D image. Cone-beam computed tomography or CBCT scanning makes it possible to improve image capture and processing speeds by directing a cone-beam source toward the subject and obtaining the image on a flat-panel X-ray detector. In cone-beam computed tomography scanning, a 3-D image is reconstructed from numerous individual scan projections, each taken at a different angle, whose image data is aligned and processed in order to generate and present data as a collection of volume pixels or voxels.

Cone-beam computed tomography (CBCT) scanning is of significant interest for biomedical, dental, and industrial applications. As flat-panel digital x-ray detectors improve in usability and performance, with reduction in image acquisition time, CBCT shows promise in providing 3-D imaging capabilities at higher image resolution using lower overall radiation dose and with simplified scanner design.

The processing of CBCT data for obtaining images requires some type of reconstruction algorithm. Various types of image reconstruction have been proposed, generally classified as either (i) exact, (ii) approximate, or (iii) iterative. Exact cone-beam reconstruction algorithms, based on theoretical work of a number of researchers, require that the following sufficient condition be satisfied: “on every plane that intersects the imaged object there exists at least one cone-beam source”. The widely used Grangeat algorithm, familiar to those skilled in CBCT image processing, is limited to circular scanning trajectory and spherical objects. Only recently, with generalization of the Grangeat formula, is exact reconstruction possible in spiral/helical trajectory with longitudinally truncated data.

Despite advances in exact methods (i, above), approximate methods (ii) continue to be more widely used. Chief among these CBCT reconstruction approaches and familiar to those skilled in the CT imaging arts are the Feldkamp/Davis/Kress (FDK) based algorithms. Advantages of the FDK method include the following:

1) FDK based algorithms may produce better spatial and contrast resolution, since they need less regularization than do more exact reconstructions.

2) FDK processing produces improved temporal resolution. Reconstruction can be performed using either full-scan or half-scan data. The shorter scanning time improves the temporal resolution, which is critical for applications such as cardiac imaging, lung imaging, CT-guided medical intervention, and orthopedics.

3) FDK algorithms are computationally efficient. Implementation of the FDK algorithm is relatively simple, straightforward, and processing can be executed in parallel with scanning.

The increasing capabilities of high-performance computers and advanced parallel programming techniques contribute to making iterative CBCT reconstruction algorithms (iii) more attractive. As one advantage, iterative approaches appear to have improved capabilities in handling noisy and truncated data. For instance, iterative deblurring via expectation minimization, combined with algebraic reconstruction technique (ART), has been shown to be effective in suppressing noise and metal artifacts.

Although 3-D images of diagnostic quality can be generated using CBCT systems and technology, however, a number of technical challenges remain. One well-recognized problem relates to the tradeoff between image quality and noise. Noise is an inherent aspect of cone beam projection data, especially for low-dose scans.

Noise is often present in acquired diagnostic images, such as those obtained from computed tomography (CT) scanning and other x-ray systems, and can be a significant factor in determining how well actual intensity interfaces and fine details are preserved in the image. In addition to influencing diagnostic functions, noise also affects many automated image processing and analysis tasks that are crucial in a number of diagnostic applications.

Image variation is inherent to the physics of image capture and is at least somewhat a result of practical design tolerances. The discrete nature of the x-ray exposure and its conversion to a detected signal invariably results in quantum noise fluctuations. This type of image noise is usually described as a stochastic noise source, whose amplitude varies as a function of exposure signal level within a projected digital image. The resulting relative noise level is inversely proportional to exposure. A second source of image noise is the flat-panel detector and signal readout circuits. In many cases, image noise that is ascribed to non-ideal image capture is modeled as the addition of a random component whose amplitude is independent of the signal level. In practice, however, several external factors, such electro-magnetic interference, can influence both the magnitude and the spatial correlations of image noise due to the detector.

Methods for improving signal-to-noise ratio (SNR) and contrast-to-noise ratio (CNR) can be broadly divided into two categories: those based on image acquisition techniques and those based on post-acquisition image processing. Improving image acquisition techniques beyond a certain point can introduce other problems and generally requires increasing the overall acquisition time. This risks delivering a higher X-ray dose to the patient and loss of spatial resolution and may require the added expense of scanner equipment upgrade. Post-acquisition filtering, an off-line image processing approach, is often as effective as improving image acquisition without affecting spatial resolution. If properly designed, post-acquisition filtering requires less time and is usually less expensive than attempts to improve image acquisition. Filtering techniques can be classified into two groupings: (i) enhancement, wherein wanted (structure) information is enhanced, ideally without affecting unwanted (noise) information, and (ii) suppression, wherein unwanted information (noise) is suppressed, ideally without affecting wanted information.

Three-dimensional (3-D) imaging introduces further complexity to the problem of noise suppression. Image filtering, an image processing approach for improving SNR and contrast-to-noise ratio (CNR) with 3-D imaging, is often as effective in compensating for noise as is optimizing the scanner design (hardware) without affecting the image contrast and the image spatio-temporal resolution.

Reconstruction algorithms that form the 3-D volume image from multiple 2-D projection images operate without compensation for noise, leaving the noise problem to be handled elsewhere in the image processing chain. Ignoring noise effects altogether in processing yields the highest spatial resolution, but with the penalty of relatively high noise levels. Applying excessive levels of noise suppression, on the other hand, reduces noise but tends to compromise spatial resolution. Using conventional diffusion techniques to reduce image noise can often blur significant features within the 3-D image, making it disadvantageous to perform more than rudimentary image clean-up for reducing noise content. Diffusion techniques are more effective where noise has a generally Gaussian distribution. However, there is some question as to whether or not this assumption for noise distribution is valid. Quantum noise, for example, is more accurately characterized as having a Poisson distribution, for which diffusion and other filtering methods are less well-suited. While utilities for handling Gaussian noise are well known to those skilled in the image processing arts, image processing techniques that compensate for Poisson noise are not widely known.

Conventional methods for suppression of noise levels apply suppression by adjusting the noise window in the FDK back-projection processing that is used to form the volume image. When applied at this point in the processing, however, the same noise suppression also compromises higher-frequency image content. Because this image content is often needed in order to provide an image that is suitable for patient diagnosis, increased noise suppression comes at the risk of reduced diagnostic accuracy. Thus, there is a compelling need for improved methods for noise suppression in the volume image reconstruction processing chain.

### SUMMARY OF THE INVENTION

An object of the present invention is to provide improved noise suppression in image processing method for CBCT images. A related object is to suppress noise content earlier in the imaging chain, prior to back projection and image reconstruction processing.

An advantage of the present invention is that it uses techniques more suitable to Poisson-distributed noise data, which is acknowledged to be more characteristic of noise probability than other statistical models.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a method for 3-D volume image reconstruction of a subject, executed at least in part on a computer and comprising: obtaining image data for a plurality of 2-D projection images over a range of scan angles; and generating, for each of the plurality of projection images, a noise-corrected projection image by steps of: (i) transforming the image data according to a variance-stabilizing transform to provide transformed image data; (ii) applying Gaussian based noise suppression to the transformed image data; (iii) inverting the transformation of the noise-suppressed transformed image data to generate the noise-corrected projection image; and storing the noise-corrected projection image in a computer-accessible memory.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a schematic diagram showing components and architecture used for CBCT scanning.

FIG. 2 is a logic flow diagram showing the sequence of processes used for conventional CBCT volume image reconstruction.

FIG. 3 is a graph that shows the row-wise linear ramp function and how it is executed in conventional 3-D reconstruction imaging.

FIG. 4 is a logic flow diagram showing the sequence of processes used for 3-D volume image processing according to one embodiment of the present invention.

### DETAILED DESCRIPTION OF THE INVENTION

The following is a detailed description of the preferred embodiments of the invention, reference being made to the drawings in which the same reference numerals identify the same elements of structure in each of the several figures.

In the drawings and text that follow, like components are designated with like reference numerals, and similar descriptions concerning components and arrangement or interaction of components already described are omitted. Where they are used, the terms “first”, “second”, and so on, do not necessarily denote any ordinal or priority relation, but may simply be used to more clearly distinguish one element from another.

CBCT imaging apparatus and the imaging algorithms used to obtain 3-D volume images using such systems are well known in the diagnostic imaging art and are, therefore, not described in detail in the present application.

Some exemplary algorithms for forming 3-D volume images from the source 2-D images, projection images that are obtained in operation of the CBCT imaging apparatus can be found, for example, in U.S. Pat. No. 5,999,587 entitled “Method of and System for Cone-Beam Tomography Reconstruction” to Ning et al. and in U.S. Pat. No. 5,270,926 entitled “Method and Apparatus for Reconstructing a Three-Dimensional Computerized Tomography (CT) Image of an Object from Incomplete Cone Beam Data” to Tam.

In typical applications, a computer or other type of dedicated logic processor for obtaining, processing, and storing image data is part of the CBCT system, along with one or more displays for viewing image results. A computer-accessible memory is also provided, which may be a non-volatile memory storage device used for longer term storage, such as a device using magnetic, optical, or other data storage media. In addition, the computer-accessible memory can comprise an electronic memory such as a random access memory (RAM) that is used as volatile memory for shorter term data storage, such as memory used as a workspace for operating upon data or used in conjunction with a display device for temporarily storing image content as a display buffer, or memory that is employed to store a computer program having instructions for controlling one or more computers to practice the method according to the present invention.

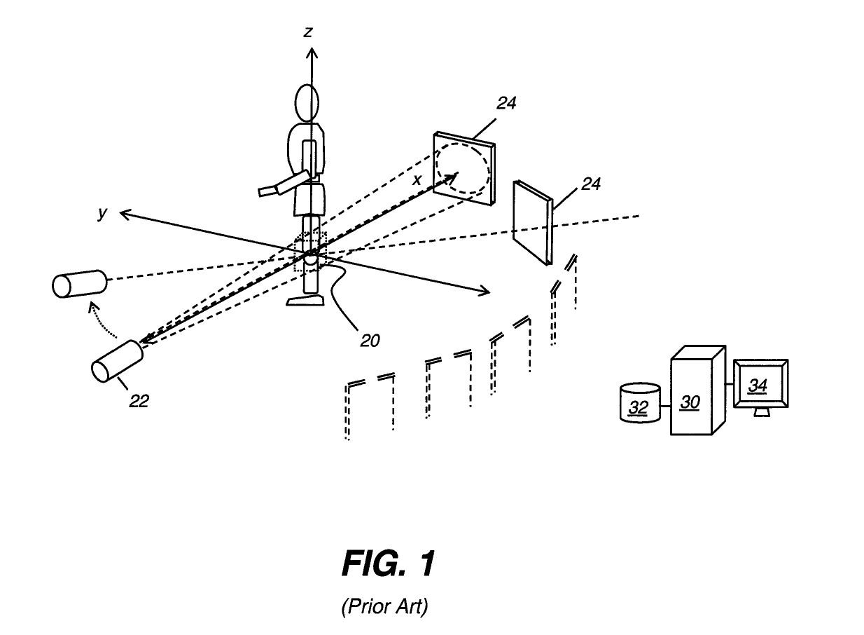

To understand the methods of the present invention and the problems addressed by embodiments of the present invention, it is instructive to review principles and terminology used for CBCT image capture and reconstruction. Referring to the perspective view of FIG. 1, there is shown, in schematic form and using exaggerated distances for clarity of description, the activity of a conventional CBCT imaging apparatus for obtaining the individual 2-D images that are used to form a 3-D volume image. A cone-beam radiation source 22 directs a cone of radiation toward a subject 20, such as a patient or other imaged subject. A sequence of images of subject 20 is obtained in rapid succession at varying angles about the subject over a range of scan angles, such as one image at each 1-degree angle increment in a 200-degree orbit. A DR detector 24 is moved to different imaging positions about subject 20 in concert with corresponding movement of radiation source 22. FIG. 1 shows a representative sampling of DR detector 24 positions to illustrate how these images are obtained relative to the position of subject 20. Once the needed 2-D projection images are captured in this sequence, a suitable imaging algorithm, such as FDK filtered back projection or other conventional technique, is used for generating the 3-D volume image. Image acquisition and program execution are performed by a computer 30 or by a networked group of computers 30 that are in image data communication with DR detectors 24. Image processing and storage is performed using a computer-accessible memory 32. The 3-D volume image can be presented on a display 34.

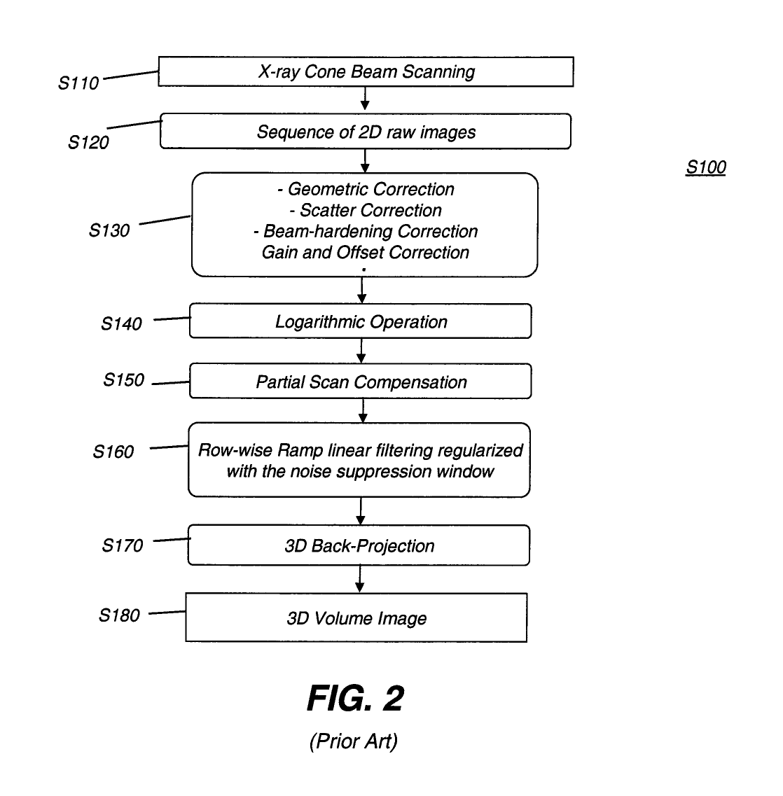

The logic flow diagram of FIG. 2 shows a conventional image processing sequence S100 for CBCT reconstruction using partial scans. A scanning step S110 directs cone beam exposure toward the subject, enabling collection of a sequence of 2-D raw data images for projection over a range of angles in an image data acquisition step S120. An image correction step S130 then performs standard processing of the projection images for geometric correction, scatter correction, gain and offset, and beam hardening. A logarithmic operation step S140 obtains the line integral data that is used for conventional reconstruction methods, such as the FDK method well-known to those skilled in the volume image reconstruction arts.

An optional partial scan compensation step S150 is then executed when it is necessary to correct for constrained scan data or image truncation and related problems that relate to positioning the detector about the imaged subject throughout the scan orbit. A ramp filtering step S160 follows, providing row-wise linear filtering that is regularized with the noise suppression window in conventional processing. A back projection step S170 is then executed and an image formation step S180 reconstructs the 3-D volume image using one or more of the non-truncation corrected images. FDK processing generally encompasses the procedures of steps S160 and S170. The reconstructed 3-D image can then be stored in a computer-accessible memory and displayed.

Conventional image processing sequence S100 of FIG. 2 has been proven and refined in numerous cases with both phantom and patient images. Improvements are needed, however, with respect to noise. In general, the overall processing sequence used by the conventional FDK algorithm assumes a relatively noise-free set of image projections. Noise correction is applied only toward the final stages of volume image reconstruction, by conditioning or regularizing the row-wise ramp linear filtering by a noise suppression window. This regularization is subject to some variability. Minimizing the noise suppression window provides increased spatial resolution, but at the cost of relatively higher noise levels. Using high levels of noise suppression corrects for much of the noise but compromises spatial resolution, causing reduced contrast, particularly troublesome for identifying fine features and detailed structures in the reconstructed image.

In conventional practice, this filtering is implemented in the Fourier domain, in which the 2-D spatial projection images are projected onto global complex sinusoids (sinograms) in order to obtain Fourier coefficients through Fourier basis functions that have support over the entire image. Because both noise and signal (image content) contribute to the Fourier coefficient for every frequency point in the Fourier domain, it is difficult in this processing sequence to separate the noise from the image content.

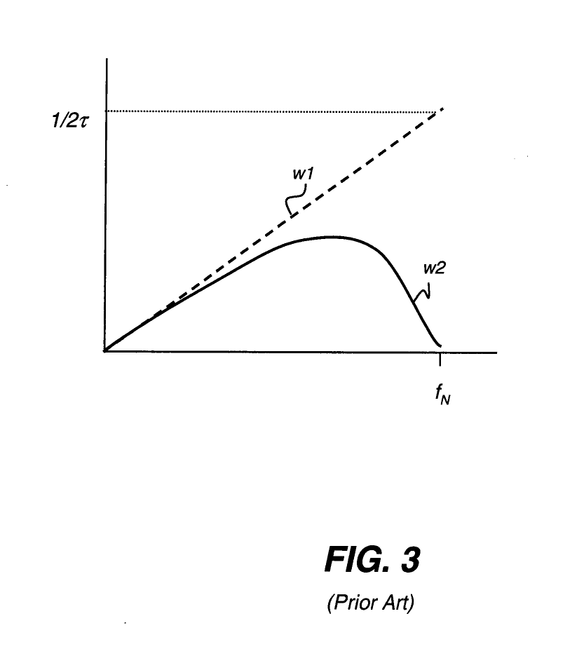

Row-wise ramp linear filtering applies a ramp filter function to obtain the reconstructed image data. The graph of FIG. 3 shows, for increasing spatial frequencies in the image up to the limits of image resolution, a linear weighting that would normally be applied to frequency content. The ideal ramp weighting is shown as a dashed line w1. In conventional row-wise ramp filtering, however, frequencies nearing the Nyquist frequency f_{N} are attenuated, as shown by a solid curve w2. As a result of this attenuation and regularization with the noise suppression window, some of the image content, such as image content that includes fine details, is suppressed along with noise content. As a related result, the overall image contrast is decreased. The value τ corresponds to the pixel pitch of the detector.

Other noise compensation methods attempt to suppress noise content using diffusion, following logarithmic operation step S140 in the sequence of FIG. 2. It has been found, however, that diffusion methods for noise correction are generally more effective in addressing Gaussian noise than in correcting for quantum noise, which is not generally found to have a Gaussian distribution.

The method of the present invention takes a different approach to the noise problem than is conventionally followed and employs noise suppression preceding logarithmic operation step S140 in the sequence of FIG. 2 and prior to the ramp linear filtering of step S160. This reduces or eliminates the need to suppress higher frequencies when filtering, as shown with respect to FIG. 3, allowing a more linear filter ramp to be used.

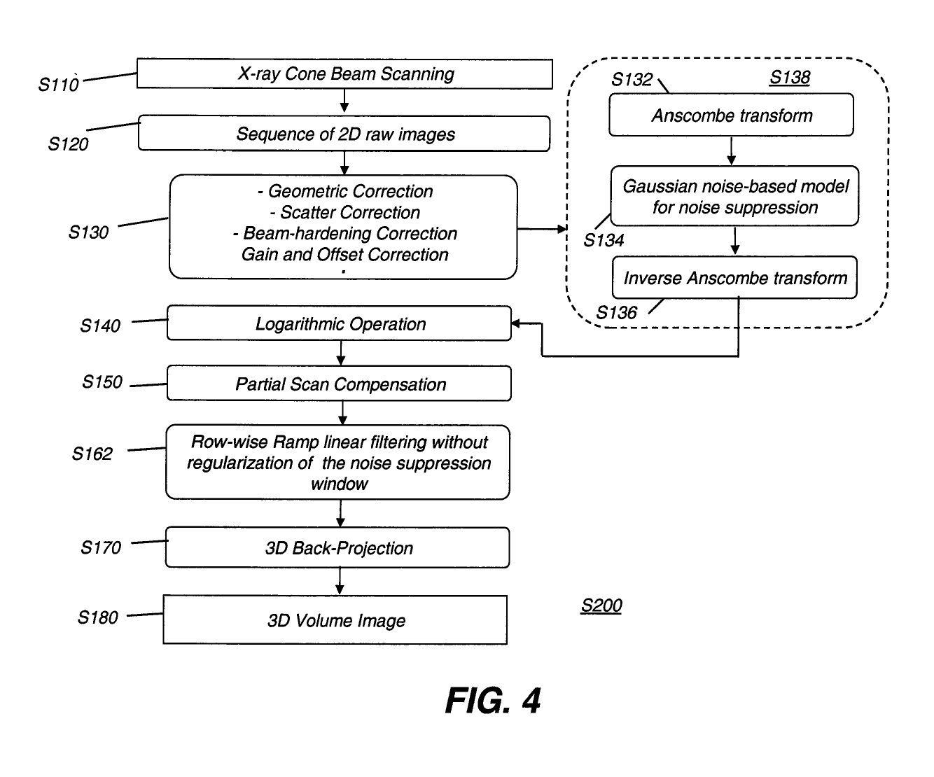

Referring to the logic flow diagram of FIG. 4, there is shown an image processing sequence 5200 according to an embodiment of the present invention. Steps S110, S120, and S130 in this sequence are the same steps described earlier for the conventional sequence of FIG. 2. In this sequence, a noise correction process S138, indicated in dashed outline in FIG. 4, follows image correction step S130 and provides an image data transformation, noise suppression, and inverse transformation to provide noise-corrected image data to logarithmic operation step S140.

For embodiments of the present invention, noise within the obtained image is assumed to be signal-dependent quantum noise and thus to have a Poisson distribution, rather than a Gaussian distribution. The sequence shown in FIG. 4 corrects for quantum noise prior to logarithmic operation step S140 by transforming the image data using a variance stabilizing transform in order to deal more effectively with noise content. It has been found that this approach has benefits over correction techniques later in the image processing chain.

The Poisson distribution is characteristic of statistical data with a number of events occurring within a given time period, wherein the probability of each event is constant. For a Poisson distribution, the mean (μ) equals the variance(σ²).

Referring to FIG. 4, a transform step S132 begins noise correction process 138, applying a variance-stabilizing transform, such as an Anscombe transform, for example, to the image data. The Anscombe transform, known to those skilled in the statistical modeling arts, is a type of variance-stabilizing transform that transforms statistical data that has a Poisson distribution into data that is at least approximately Gaussian in distribution, with a variance that is approximately equal to 1. Noise suppression techniques are then applied to the transformed data in a noise suppression step S134. Following noise suppression, an inverse transform step S136 is executed, restoring the projection image data, now noise-corrected, to its previous form. Each noise-corrected projection image is stored in computer-accessible memory, ready for logarithmic operation step S140 and partial scan compensation step 150, as was described earlier with reference to FIG. 2. Steps S132 and S136 show the use of an Anscombe transform, but it should be observed that any suitable type of variance-stabilizing transform that is invertible and obtains a more Gaussian distribution of the noise content can be used.

With noise compensation already applied to the image data, ramp filtering step S162 is next executed, but without requiring attenuation of the ramp function as was described with reference to curve w2 in FIG. 3. Differently stated, step S162 performs ramp filtering but does not require regularization of the noise suppression window. Instead, because there is no need to suppress noise data at this later point in processing, linear ramp w1 can be applied to the data. This helps to provide improved contrast in the reconstructed volume image.

Embodiments of the present invention provide noise correction to the individual 2-D projection images rather than applying this correction at a later stage, such as during 3-D image reconstruction itself. By applying image noise correction earlier in the image processing chain, methods of the present invention are able to provide improved image contrast and detail, allowing for more complete information for diagnosis.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

20. Subject
22. Radiation source
24. DR detector
30. Computer
32. Memory
34. Display
S100. Image processing sequence
S110. Scanning step
S120. Image data acquisition step
S130. Image correction step
S132. Transform step
S134. Noise suppression step
S136. Inverse transform step
S138. Noise correction process
S140. Logarithmic operation step
S150. Partial scan compensation step
S160. Row-wise ramp filtering step
S162. Row-wise ramp filtering step
S170. Back projection step
S180. Image formation step
S200. Image processing sequence
x, y. Axis
z. Rotation axis
τ. Detector pixel pitch
w1. Line
w2. Curve

What is claimed is:

1. A method for 3-D volume image reconstruction of a subject, executed at least in part on a computer, comprising:
obtaining image data for a plurality of 2-D projection images over a range of scan angles;
generating, for each of the plurality of projection images, a noise-corrected projection image by:
(i) transforming the image data according to a variance-stabilizing transform to provide transformed image data;
(ii) applying Gaussian-based noise suppression to the transformed image data; and
(iii) inverting the transformation of the noise-suppressed transformed image data to generate the noise-corrected projection image; and
storing the noise-corrected projection image in a computer-accessible memory.

2. The method of claim 1 further comprising processing the plurality of noise-corrected projection images to reconstruct the 3-D volume image of the subject.

3. The method of claim 2 further comprising displaying the reconstructed 3-D volume image.

4. The method of claim 2 further comprising storing the reconstructed 3-D volume image in the computer-accessible memory.

5. The method of claim 1 wherein transforming the image data according to a variance-stabilizing transform comprises applying an Anscombe transform.

6. The method of claim 2 wherein processing the plurality of noise-corrected projection images comprises performing a row-wise ramp linear filtering to the projection image data without regularization of the noise suppression window.

7. The method of claim 1 wherein obtaining image data for a plurality of 2-D projection images comprises obtaining image data from a cone-beam computerized tomography apparatus.

8. A method for 3-D volume image reconstruction of a subject, executed at least in part on a computer, comprising:
obtaining cone-beam computed tomography image data for a plurality of 2-D projection images over a range of scan angles;
generating, for each of the plurality of projection images, a noise-corrected projection image by:
(i) transforming the image data according to a variance-stabilizing transform to provide transformed image data;
(ii) applying Gaussian based noise suppression to the transformed image data; and
(iii) inverting the transformation of the noise-suppressed transformed image data to generate the noise-corrected projection image;
processing the plurality of noise-corrected projection images to reconstruct the 3-D volume image of the subject; and
displaying the reconstructed 3-D volume image.

9. The method of claim 8 further comprising storing the reconstructed 3-D volume image in a computer-accessible memory.

10. The method of claim 8 wherein transforming the image data according to a variance-stabilizing transform comprises applying an Anscombe transform.

11. The method of claim 8 wherein processing the plurality of noise-corrected projection images comprises performing a row-wise ramp linear filtering to the projection image data without regularization of the noise suppression window.

12. The method of claim 8 further comprising performing one or more of geometric correction, scatter correction, beam-hardening correction, and gain and offset correction on the obtained image data.
